(19) United States
(12) Patent Application Publication
(10) Pub. No.: US 2019/0132140 A1
(43) Pub. Date: May 2, 2019

(54) METHOD FOR WAKING ON APPLICATION AND WAKE ON DEVICE

(71) Applicant: QINGDAO HISENSE ELECTRONICS CO., LTD., Qingdao (CN)

(72) Inventors: WEITING XIAO, QINGDAO (CN); ZHENXING WEN, QINGDAO (CN)

(21) Appl. No.: 16/112,636

(22) Filed: Aug. 24, 2018

Related U.S. Application Data
(63) Continuation of application No. PCT/CN2018/076229, filed on Feb. 11, 2018.

(30) Foreign Application Priority Data
Oct. 31, 2017 (CN) 201711046413.3

(51) Int. Cl. H04L 12/12; G06F 9/4401

(52) U.S. Cl. CPC H04L 12/12; G06F 9/4418

(57) ABSTRACT

Provided are a method for waking on application and a electronic device, where the method includes: enabling, by an application of a source device, a Wake on LAN function after a connection is established between the source device and a destination device; acquiring a MAC address of a communication port of the source device and an identifier of the application of the source device; and sending at least one first notification message to the destination device so that the destination device wakes on an application of the source device according to the first notification message, where the first notification message includes the MAC address of the communication port of the source device and the identifier of the application of the source device. According to the method and the electronic device provided in the embodiments of the present application, an application in one device can be woken on by another device.

### CROSS-REFERENCE TO RELATED APPLICATIONS

This application is a continuation of International Patent Application No. PCT/CN2018/076229, filed on Feb. 11, 2018, which claims the priority benefit of Chinese Patent Application No. 201711046413.3, filed on Oct. 31, 2017. The contents of the above identified applications are incorporated herein by reference in their entireties.

### TECHNICAL FIELD

Embodiments of the present application relate to network communication technologies and, in particular, to a method for waking on application and an electronic device.

### BACKGROUND

The remote wake-on function of network devices has been known for a long time. This function was originally proposed by AMD (Advanced Micro Devices, Inc.), which defines the Wake on LAN (Wake on LAN, WOL for short) standard that using a magic packet carried with an media access control (MAC) address of a source device to perform transmission between the source device and a destination device in the local area network via the user datagram protocol (User Datagram Protocol, UDP for short) and the internet protocol (Internet Protocol, IP for short). When a network card of the source device receives the magic packet with its own MAC address, it will resume the operating mode of the device from the sleep mode to the normal mode to complete the wake-on procedure.

### SUMMARY

Embodiments of the present application provide a method for waking on application and an electronic device, which are used to wake on an application in one device through another device.

Some embodiments of the present application provides a method for waking on application, where the method includes:

upon connecting with a destination device, enabling, by an application of a source device, a Wake on LAN function;

acquiring a MAC address of a communication port of the source device and an identifier of an application of the source device; and

sending at least one first notification message to the destination device so that the destination device wakes on the application of the source device according to the first notification message, where the first notification message includes the MAC address of the communication port of the source device and the identifier of the application of the source device.

In some embodiments, the first notification message further includes: a first time, wherein the first time is an expire time of the MAC address of the communication port.

In some embodiments, the acquiring a MAC address of a communication port of the source device includes:

acquiring a MAC address of a wireless communication port which matches with the application.

In some embodiments, the acquiring a MAC address of a communication port of the source device includes:

acquiring a MAC address of a wired communication port which matches with the application.

In some embodiments, the acquiring a MAC address of a communication port of the source device includes:

acquiring MAC addresses of at least two communication ports of the source device.

In some embodiments, the first notification message is a message frame for enabling the WOL function, where the message frame includes more or all of a command identification field, an application identifier field, a MAC address field, and a timeout setting field.

Some embodiments of the present application provides a method for waking on application, where the method includes:

upon connecting with the source device, receiving at least one first notification message sent by a source device, wherein the first notification message includes a MAC address of a communication port of the source device and an identifier of an application of the source device; and

sending a wake-on message to a MAC address corresponding to the identifier of the application of the source device, when executing an operation for waking on the application.

Some embodiments of the present application provides an electronic device, including: a memory configured to store computer instructions and a processor coupled to the memory, where the processor is configured to execute the instructions stored in the memory to cause the electronic device to:

when the electronic device connects with a destination device and the application running on the electronic device enables a Wake on LAN (WOL) function, acquire a MAC address of a communication port of the electronic device and an identifier of an application of the electronic device; and

send at least one first notification message to the destination device so that the destination device wakes on the application of the source device according to the first notification message, where the first notification message includes the MAC address of the communication port of the electronic device and the identifier of the application of the electronic device.

In some embodiments, the first notification message further includes: a first time, wherein the first time is an expire time of the MAC address of the communication port.

In some embodiments, the processor acquires the MAC address of the communication port of the electronic device through the following operation:

acquiring a MAC address of a wireless communication port which matches with the application.

In some embodiments, the processor acquires the MAC address of the communication port of the electronic device through the following operation:

acquiring a MAC address of a wired communication port which matches with the application.

In some embodiments, the processor acquires the MAC address of the communication port of the electronic device through the following operation: acquiring MAC addresses of at least two communication ports of the electronic device.

In some embodiments, the first notification message is a message frame for enabling the WOL function, where the message frame includes more or all of a command identification field, an application identifier field, a MAC address field, and a timeout setting field.

Some embodiments of the present application provides an electronic device, including: a memory configured to store computer instructions and a processor coupled to the memory, where the processor is configured to execute the instructions stored in the memory to cause the electronic device to:

when the electronic device connects with a source device, receive at least one first notification message sent by the source device, where the first notification message includes a MAC address of a communication port of the source device and an identifier of an application of the source device; and

send a wake-on message to a MAC address corresponding to the identifier of the application of the source device, when executing an operation of waking on the application.

### BRIEF DESCRIPTION OF DRAWING(S)

To describe technical solutions in the embodiments of the present application or in the prior art more clearly, accompanying drawings used for describing the embodiments or the prior art will be briefly described hereunder. Apparently, the accompanying drawings in the following description show merely some embodiments of the present application, and persons of ordinary skill in the art may still derive other drawings from these accompanying drawings without creative efforts.

FIG. 1 shows a flowchart of a method for waking on application according to an embodiment of the present application;

FIG. 2 shows a schematic structural diagram of a first notification message according to an embodiment of the present application;

FIG. 3 shows a schematic structural diagram of a second notification message according to an embodiment of the present application;

FIG. 4 shows a flowchart of a method for waking on application according to an embodiment of the present application;

FIG. 5 shows a schematic structural diagram of an electronic device according to an embodiment of the present application; and

FIG. 6 shows a schematic structural diagram of an electronic device according to an embodiment of the present application.

### DESCRIPTION OF EMBODIMENTS

The technical solutions in the embodiments of the present application will be clearly and completely described below with reference to the accompanying drawings in the embodiments of the present application. Apparently, the described embodiments are merely some but not all of the embodiments of the present application. All other embodiments obtained by a person of ordinary skill in the art based on the embodiments of the present application without creative efforts shall fall within the protection scope of this application.

The terms such as “including” and “having” of the description and claims of this application as well as any variation thereof are intended to cover a non-exclusive inclusion. For example, a process including a series of steps or an apparatus including a series of structures is not necessarily to be limited to those structures or steps explicitly listed, but may include other steps or structures not expressly listed or inherent to such process or apparatus.

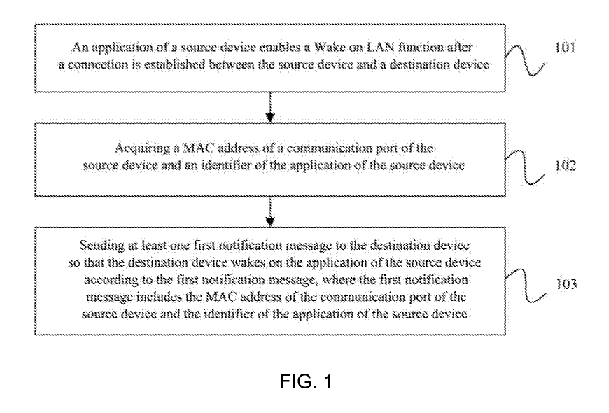

Some embodiments of the present application provide a method for waking on application. The method is performed by an electronic device for waking on application (an electronic device for short), and the electronic device is set in a source device described below. Reference is made to FIG. 1. FIG. 1 shows a flowchart of a method for waking on application according to an embodiment of the present application. As shown in FIG. 1, the method includes the following steps:

Step 101: an application of a source device enables a Wake on LAN function after a connection is established between the source device and a destination device.

The source device and the destination device involved in the embodiments may be devices having the Wake on LAN function, such as a mobile phone, a tablet computer, a television, a laptop computer, and so on.

In the embodiments, only one application is waked up in one device at a time, but a plurality of applications that support the Wake on LAN function may be set in one device at the same time.

In the embodiments, the connection between the source device and the destination device may be a connection between devices, or may be a connection between applications. In the embodiments, the connection between applications is established. In these embodiments, the search, match and connection establishment between the source device and the destination device follows the universal plug and play protocol (UPnP) or other specifications, for which a specific implementation process will not be described herein again.

Step 102: acquiring a MAC address of a communication port of the source device and an identifier of the application of the source device.

In the embodiments, when the application of the source device enables the Wake on LAN function, the application sends a first request message to the electronic device, where the first request message carries at least an identifier of the application of the source device. In some embodiments, information about a type of the communication port of the source device, an IP address of the application of the source device, and an IP address of an application of the destination device connected to the application of the source device may also be included in the message. The information about the type of the communication port is used to indicate a requirement by the application to a communication port for receiving a wake-on message (such as a requirement of only receiving a wake-on message from a wired port). The IP address of the application of destination device is acquired after the connection between the source device and the destination device is established.

The acquired MAC address of the communication port of the source device in the embodiments includes a MAC address of a wireless port and/or a MAC address of a wired port of the source device. In the embodiments, MAC addresses of at least two available communication ports of the source device are acquired. The word “available” means that these ports are available at the physical layer, whether or not these ports are in activated state, this is not limited.

In some embodiments, when the first request message includes the information about the type of the communication port, the electronic device only acquires, in the source device, a MAC address of a communication port which matches with the information about the type. For example, when the application requires only receiving the wake-on message from the wired port, the electronic device only acquires the MAC address of at least one wired port available on the source device. That is to say, in these embodiments, the acquiring, in the source device, the MAC address of the communication port which matches with the information about the type may be performed by acquiring a MAC address of a wireless communication port which matches with the application or a MAC address of a wired communication port which matches with the application. Of course, this is intended to be an illustration rather than limitation.

Step 103: sending at least one first notification message to the destination device so that the destination device wakes on the application of the source device according to the first notification message, where the first notification message includes the MAC address of the communication port of the source device and the identifier of the application of the source device.

Specifically, the first notification message in the embodiments at least includes the identifier of the application of the source device and the above-acquired MAC address of the communication port of the source device. In some embodiments, a first time for timeout setting and the IP address of the communication port of the source device may be further included, where the first time is used to indicate a duration at which the MAC address acquired above will be valid. The MAC address acquired above is valid until the first time expires, and the MAC address acquired above is invalid after the first time expires.

In some embodiments, the first time is carried in the first request message when the application of the source device sends the first request message, in other embodiments, the first time is set by the source device itself according to a preset policy.

When a plurality of MAC addresses are acquired for the source device, the source device sends a plurality of first notification messages to the destination device. Each of the first notification messages includes a MAC address of the source device and an identifier of an application of the source device until all acquired MAC addresses of the source device are sent to the destination device.

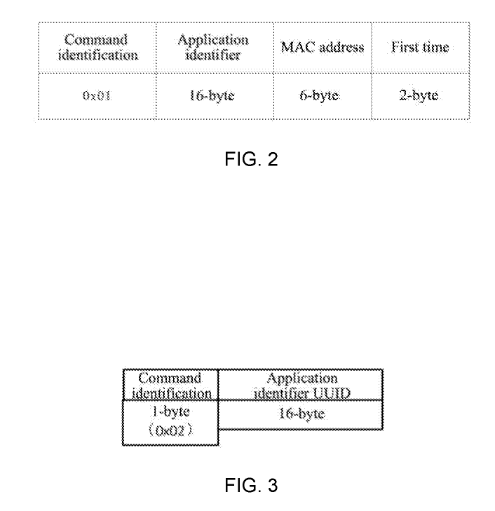

FIG. 2 shows a schematic structural diagram of a first notification message according to an embodiment of the present application. The first notification message is in a form of a message frame as shown in FIG. 2, when the first notification message is a message frame for enabling the Wake on function, the message frame at least includes a command identification field, an application identifier field, a MAC address field, and a timeout setting field. As shown in FIG. 2, when the text in the command identification field is a preset text (“0x01” in FIG. 2), it indicates that the first notification message (in the form of the message frame) is used for enabling the Wake on function. At this point, the 16-byte in the application identifier field is the identifier of the application; the 6-byte in the MAC address field is used to indicate the MAC address corresponding to the application of the source device; the 2-byte in the timeout setting field is used to indicate a value of the first time. It is noted that these forms are intended for illustration rather than limitation.

Upon receiving the at least one first notification message, the destination device stores identifiers carried in the notification message in association with the MAC addresses of applications carried in the first notification message.

Table 1 is an example showing the correspondence between the identifiers and the MAC addresses of the applications stored by the destination device.

As shown in Table 1, the application identifier UUID1 and the application identifier UUID3 respectively represent two applications run on the same device which has three available communication ports. The application represented by UUID1 may allow three communication ports to wake on, but the application represented by UUID3 only allows one of the communication ports (MAC address −33:56:6A:23:1B:C7) to wake on. The application represented by UUID2 run on another device. Different applications have different first times, but different Wake on ports of the same application will have the same first time. Of course, Table 1 is merely an example to illustrate how the destination device stores the identifier and the MAC address of the application, rather than limit the present invention.

TABLE 1

| Application | | | |
|---|---|---|---|
| identification UUID | IP address | MAC address | First time |
| UUID1 | 192.168.1.123 | 33:56:6A:23:1B:C7 | 1200 s |
| UUID1 | 192.168.1.125 | A0:12:45:67:09:12 | 1200 s |
| UUID1 | 192.168.1.133 | A0:73:27:56:90:09 | 1200 s |
| UUID2 | 192.168.1.100 | 56:78:12:09:88:A2 | 3000 s |
| UUID3 | 192.168.1.123 | 33:56:6A:23:1B:C7 | 1800 s |

When performing an operation of initiating Wake on application, the destination device locally searches all MAC addresses corresponding to an identifier according to the identifier of an application. Further, the destination device may choose to send wake-on messages to all MAC addresses acquired through the search, or may choose to send a wake-on message to one or more MAC addresses of all MAC addresses acquired through the search.

In some embodiments, the method further includes disenabling the Wake on LAN function of the application. Specifically, when the electronic device receives a second request message requested by the application in the source device to disenable the Wake on LAN function, firstly, acquiring an identifier of the application of the source device from the second request message, and then packaging the identifier of the application of the source device in the second notification message and send the message to the destination device so that the destination device deletes a locally stored correspondence between the identifier and the MAC address of the application according to the second notification message to shut down a service of waking on the application.

FIG. 3 shows a schematic structural diagram of a second notification message according to an embodiment of the present application. The second notification message may be in a form of a message frame as shown in FIG. 3. As shown in FIG. 3, when the text under the command identification field is a preset text form (“0x02” in FIG. 3), it indicates that the second notification message (in the form of the message frame) is used for disenabling the Wake on function. 16-byte in the application identifier field is the identifier of the application of the source device. It is noted that these forms are intended for illustration rather than limitation.

In some embodiments of the present application, acquiring a MAC address of a communication port of the source device and an identifier of an application of the source device when a connection is established between the source device and a destination device and the application of the source device enables a Wake on function; and sending a first notification message that includes the MAC address of the communication port of the source device and the identifier of the application of the source device to the destination device so that the destination device is able to send a wake-on message for waking on the application to the MAC address corresponding to the identifier of the application based on the first notification message, thereby achieving the purpose of waking on the application of the source device. Furthermore, since the destination device is capable of sending the wake-on message to a plurality of MAC addresses corresponding to the identifier of the application, compared with a scenario where the wake-on message is sent to a single MAC address, the success probability of wake-on is raised.

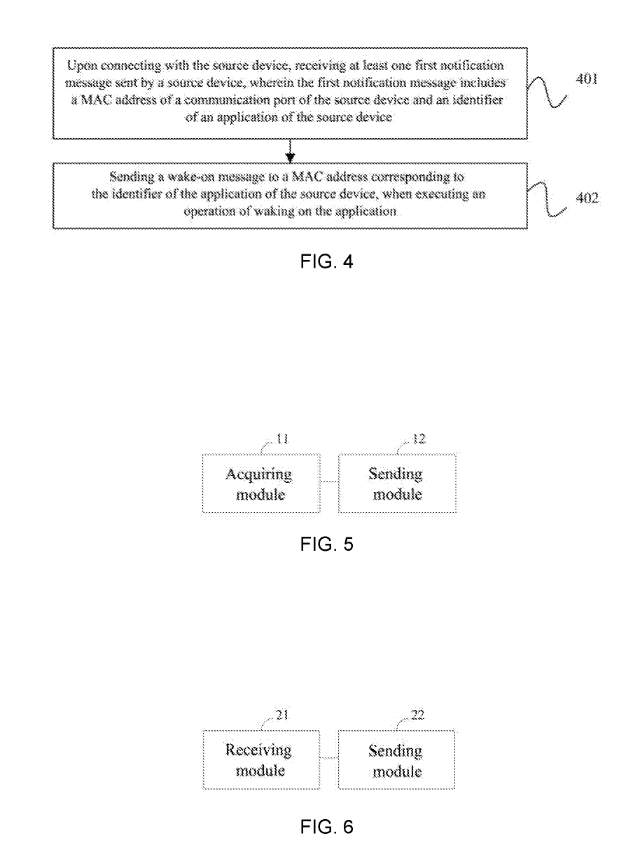

Some embodiments of the present application provide a method for waking on application. The method is performed by an electronic device for waking on application (an electronic device for short), and the electronic device is set in the destination device described below. Reference may be made to FIG. 4. FIG. 4 shows a flowchart of a method for waking on application according to an embodiment of the present application. As shown in FIG. 4, the method includes:

step 401: upon connecting with the source device, receiving at least one first notification message sent by a source device, wherein the first notification message includes a MAC address of a communication port of the source device and an identifier of an application of the source device.

In some embodiments, the receiving at least one first notification message sent by a source device includes:

receiving at least one message frame sent by the source device, where each message frame includes a MAC address and an identifier of an application in the source device.

Step 402: sending a wake-on message to a MAC address corresponding to the identifier of the application of the source device, when executing an operation of waking on the application.

In some embodiments, the first notification message further includes: a first time, wherein the first time is an expire time of the MAC address of at least one available communication port carried in the first notification message.

In some embodiments, the method further includes: receiving a second notification message sent by the source device, where the second notification message includes an identifier of an application in the source device; deleting a locally stored correspondence between the identifier and MAC address of the application to shut down a service of waking on the application.

Specific implementations and beneficial effects of the method provided in these embodiments are similar to those in the embodiment as shown in FIG. 1, and details will be not described herein again.

FIG. 5 shows a schematic structural diagram of an electronic device according to an embodiment of the present application; as shown in FIG. 5, the electronic device includes:

an acquiring module 11, configured to, when the electronic device connects with a destination device and the application running on the electronic device enables a Wake on LAN (WOL) function, acquire a MAC address of a communication port of the electronic device and an identifier of an application of the electronic device; and

a sending module 12, configured to send at least one first notification message to the destination device so that the destination device wakes on the application of the source device according to the first notification message, where the first notification message includes the MAC address of the communication port of the electronic device and the identifier of the application of the electronic device.

In some embodiments, the first notification message further includes: a first time, wherein the first time is an expire time of the MAC address of the at least one available communication port.

In some embodiments, the acquiring module is configured to: acquire a MAC address of a wireless communication port which matches with the application.

In some embodiments, the acquiring module is configured to: acquire a MAC address of a wired communication port which matches with the application.

In some embodiments, the acquiring module is configured to acquire MAC addresses of at least two communication ports of the electronic device.

In some embodiments, the sending module is configured to send a message frame to the destination device, where each message frame includes a MAC address and an identifier of the application until all acquired MAC addresses of the communication port are sent to the destination device.

In some embodiments, the electronic device further includes: a second receiving module, configured to receive a second request message requested by the application of the electronic device to disenable a Wake on function, where the second request message includes an identifier of the application; and a second sending module, configured to send a second notification message to the destination device, where the second notification message includes an identifier of the application so that the destination device shuts down a service of waking on the application according to the second notification message.

The electronic device provided in this embodiment can implement the technical solution in the embodiment as shown in FIG. 1, and implementations and beneficial effects are similar, and details will not be described herein again.

The present application also provides an electronic device, including: a memory configured to store computer instructions and a processor coupled to the memory, where the processor is configured to execute the instructions stored in the memory to: acquire a MAC address of a communication port of the electronic device and an identifier of an application of the electronic device when the electronic device connects with a destination device and the application running on the electronic device enables a Wake on LAN function; and send at least one first notification message to the destination device so that the destination device wakes on the application of the source device according to the first notification message, where the first notification message includes the MAC address of the communication port of the electronic device and the identifier of the application of the electronic device.

The processor in the electronic device according to this embodiment may further be configured to execute the method for waking on application provided in the embodiment as shown in FIG. 1 of this application, implementation principles thereof are similar, and details will not be described herein again.

FIG. 6 is a schematic structural diagram of an electronic device according to an embodiment of the present application; as shown in FIG. 6, the electronic device includes:

a receiving module 21, configured to, when the electronic device connects with a source device, receive at least one first notification message sent by the source device, wherein the first notification message includes a MAC address of a communication port of the source device and an identifier of an application of the source device; and

a sending module 22, configured to send a wake-on message to a MAC address corresponding to the identifier of the application of the source device when executing an operation of waking on the application.

In some embodiments, the first notification message further includes: a first time, wherein the first time is an expire time of the MAC address of the communication port.

In some embodiments, the receiving module is configured to receive at least one message frame sent by the source device, wherein each message frame includes a MAC address and an identifier of the application in the source device.

In some embodiments, the electronic device further includes: a second receiving module configured to receive a second notification message sent by the source device, wherein the second notification message includes the identifier of the application in the source device; a deleting module configured to delete a locally stored correspondence between the identifier and MAC address of the application to shut down a service of waking on the application.

The electronic device provided in this embodiment can implement the technical solution in the embodiment as shown in FIG. 4, implementations and beneficial effects are similar, and details will not be described herein again.

The present application also provides an electronic device, including: a memory configured to store computer instructions and a processor coupled to the memory, where the processor is configured to execute the instructions stored in the memory to: receive at least one first notification message sent by a source device, after a connection is established with the source device, wherein the first notification message includes a MAC address of a communication port of the source device and an identifier of an application of the source device; and send a wake-on message to a MAC address corresponding to the identifier of the application of the source device, when executing an operation of waking on the application.

The processor in the device according to this embodiment may further be configured to execute the method for waking on application provided in the embodiment as shown in FIG. 4 of this application, implementation principles thereof are similar, and details will not be described herein again.

Finally, it should be noted that those skilled in the art may understand that all or part of processes of the method in the foregoing embodiments may be implemented by instructing relevant hardware through a computer program, and the program may be stored in a computer-readable storage medium. When the program is executed, the process of the embodiment of each method may be included. The storage medium may be a magnetic disk, an optical disk, a read only memory (ROM), a random access memory (RAM), or the like.

Each of the functional units in the embodiments of the present application may be integrated into one processing module, or each of the units may exist alone physically, or two or more units may be integrated into one module. The above-mentioned integrated module may be implemented in the form of hardware or in the form of software functional module. When being implemented in the form of a software functional module and sold or used as an independent product, the integrated module may also be stored in a computer readable storage medium. The above-mentioned storage medium may be a read only memory, a magnetic disk, an optical disk, or the like.

The foregoing embodiments are merely intended for describing the technical solutions of the present application, but not for limiting the present application. Although the present application has been described in detail with reference to the foregoing embodiments, it should be understood by those of ordinary skill in the art that: the technical solutions described in the foregoing embodiments may still be modified or equivalent replacements may be made to some or all of the technical features in the embodiments. However, these modifications or replacements do not make the essence of corresponding technical solutions depart from the scope of the technical solutions in the embodiments of the present application.

What is claimed is:

1. A method for waking on application, comprising:
upon connecting with a destination device, enabling, by an application of a source device, a Wake on LAN (WOL) function;
acquiring a media access control (MAC) address of a communication port of the source device and an identifier of the application of the source device; and
sending at least one first notification message to the destination device so that the destination device wakes on the application of the source device according to the first notification message, wherein the first notification message comprises the MAC address of the communication port of the source device and the identifier of the application of the source device.

2. The method according to claim 1, wherein the first notification message further comprises: a first time, wherein the first time is an expire time of the MAC address of the communication port.

3. The method according to claim 1, wherein the acquiring a MAC address of a communication port of the source device comprises:
acquiring a MAC address of a wireless communication port which matches with the application.

4. The method according to claim 1, wherein the acquiring a MAC address of a communication port of the source device comprises:
acquiring a MAC address of a wired communication port which matches with the application.

5. The method according to claim 1, wherein the acquiring a MAC address of a communication port of the source device comprises:
acquiring MAC addresses of at least two communication ports of the source device.

6. The method according to claim 1, wherein the first notification message is a message frame for enabling the WOL function, wherein the message frame comprises more or all of a command identification field, an application identifier field, a MAC address field, and a timeout setting field.

7. A method for waking on application, comprising:
upon connecting with the source device, receiving at least one first notification message sent by a source device, wherein the first notification message comprises a media access control (MAC) address of a communication port of the source device and an identifier of an application of the source device; and
sending a wake-on message to a MAC address corresponding to the identifier of the application of the source device, when executing an operation for waking on the application.

8. An electronic device, comprising: a memory configured to store computer instructions and a processor coupled to the memory, wherein the processor is configured to execute the instructions stored in the memory to cause the electronic device to:
when the electronic device connects with a destination device and the application running on the electronic device enables a Wake on LAN (WOL) function, acquire a media access control (MAC) address of a communication port of the electronic device and an identifier of an application of the electronic device; and
send at least one first notification message to the destination device so that the destination device wakes on the application of the source device according to the first notification message, wherein the first notification message comprises the MAC address of the communication port of the electronic device and the identifier of the application of the electronic device.

9. The electronic device according to claim 8, wherein the first notification message further comprises: a first time, wherein the first time is an expire time of the MAC address of the communication port.

10. The electronic device according to claim 8, the processor acquires the MAC address of the communication port of the electronic device through the following operation:
acquiring a MAC address of a wireless communication port which matches with the application.

11. The electronic device according to claim 8, the processor acquires the MAC address of the communication port of the electronic device through the following operation:
acquiring or a MAC address of a wired communication port which matches with the application.

12. The electronic device according to claim 8, the processor acquires the MAC address of the communication port of the electronic device through the following operation:
acquiring MAC addresses of at least two communication ports of the electronic device.

13. The electronic device according to claim 8, wherein the first notification message is a message frame for enabling the WOL function, wherein the message frame comprises more or all of a command identification field, an application identification field, a MAC address field, and a timeout setting field.

14. An electronic device, comprising: a memory configured to store computer instructions and a processor coupled to the memory, wherein the processor is configured to execute the instructions stored in the memory to cause the electronic device to:
when the electronic device connects with a source device, receive at least one first notification message sent by the source device, the first notification message comprising a media access control (MAC) address of a communication port of the source device and an identifier of an application of the source device; and
send a wake-on message to a MAC address corresponding to the identifier of the application of the source device, when executing an operation of waking on the application.
